(19) United States
(12) Patent Application Publication
(10) Pub. No.: US 2012/0214088 A1
(43) Pub. Date: Aug. 23, 2012

(54) HYDROGEN STORAGE TANK

(75) Inventor: Patrick Breuer, Montabaur (DE)

(73) Assignee: GM GLOBAL TECHNOLOGY OPERATIONS, INC., Detroit, MI (US)

(21) Appl. No.: 13/030,574

(22) Filed: Feb. 18, 2011

(51) Int. Cl. H01M 8/04

(52) U.S. Cl. 429/515

(57) ABSTRACT

A pressure vessel includes an inner shell formed from a moldable material, an intermediate shell formed over the inner shell, and an outer shell formed over the intermediate shell. The inner shell has an inner surface that defines a cavity, and the outer shell is formed with a high temperature epoxy resin.

### FIELD

The present invention relates to a hydrogen storage tank. More specifically, the present invention relates to a hydrogen storage tank with an outer epoxy layer including an epoxy layer.

### BACKGROUND

The statements in this section merely provide background information related to the present disclosure and may not constitute prior art.

Fuel cells have been proposed as a power source for electric vehicles and other applications. In proton exchange membrane type fuel cells, hydrogen is supplied as a fuel to an anode of the fuel cell, and oxygen is supplied as an oxidant to a cathode of the fuel cell. Typically, a plurality of fuel cells is stacked together in a fuel cell stack to form a fuel cell system. The fuel and oxidant are stored in pressurized hollow vessels such as fuel tanks, which, for example, can be stored on an undercarriage of the vehicle.

A typical pressurized vessel includes an inner shell, an intermediate shell formed over the inner shell, and an outer shell formed over the intermediate shell. The inner shell is typically formed over an exterior portion of, or on an interior portion of a finish, such as a metallic boss. The boss may be in communication with a valve or may be in fluid communication with other vessel fittings such as a pressure relief valve, a nozzle, a conduit, or any other suitable fitting.

To minimize the effects of thermal energy on the inner shell of typical vessels, in some applications, a metal shell is formed around the outer shell of the vessel. Formation of such metal shells, however, is labor intensive, increases weight of the vessels, and maximizes both the assembly and material costs of the vessels.

Accordingly, it would be desirable to develop a hollow pressure vessel adapted to minimize the effect of thermal energy on the vessel, while also minimizing the assembly and material costs of such vessels.

### SUMMARY

In a general aspect of the present invention a pressure vessel includes an inner shell formed from a moldable material, an intermediate shell formed over the inner shell, and an outer shell formed over the intermediate shell. The inner shell has an inner surface that defines a cavity, and the outer shell is formed with a high temperature epoxy resin.

In another aspect, a pressure vessel includes an inner shell, an intermediate shell formed of a carbon fiber composite and a first epoxy resin, and an outer shell formed of a fiber and a second epoxy resin that deteriorates at a higher temperature than the first epoxy resin.

In yet another aspect, a pressure vessel includes an inner shell formed from a moldable material, an intermediate shell formed over the inner shell, an outer shell formed over the intermediate shell. The intermediate shell is formed of a carbon fiber composite and a first epoxy resin, and the outer shell is formed of a glass fiber and a second epoxy resin that deteriorates at a higher temperature than the first epoxy resin. The pressure vessel further includes a metallic boss attached to an end of the inner shell to provide fluid communication from the interior of the vessel to the exterior of the vessel.

Further features, advantages, and areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way. The components in the figures are not necessarily to scale, emphasis instead being placed upon illustrating the principles of the invention. In the drawings:

FIG. 1A is a perspective partially section view of a pressure vessel in accordance with the principles of the present invention;

FIG. 1B is an enlarged fragmentary cross-sectional view of the region B of the vessel in FIG. 1; and

FIG. 2 is a cross-sectional view of the vessel in FIG. 1.

### DETAILED DESCRIPTION

The following description is merely exemplary in nature and is not intended to limit the present disclosure, application, or uses.

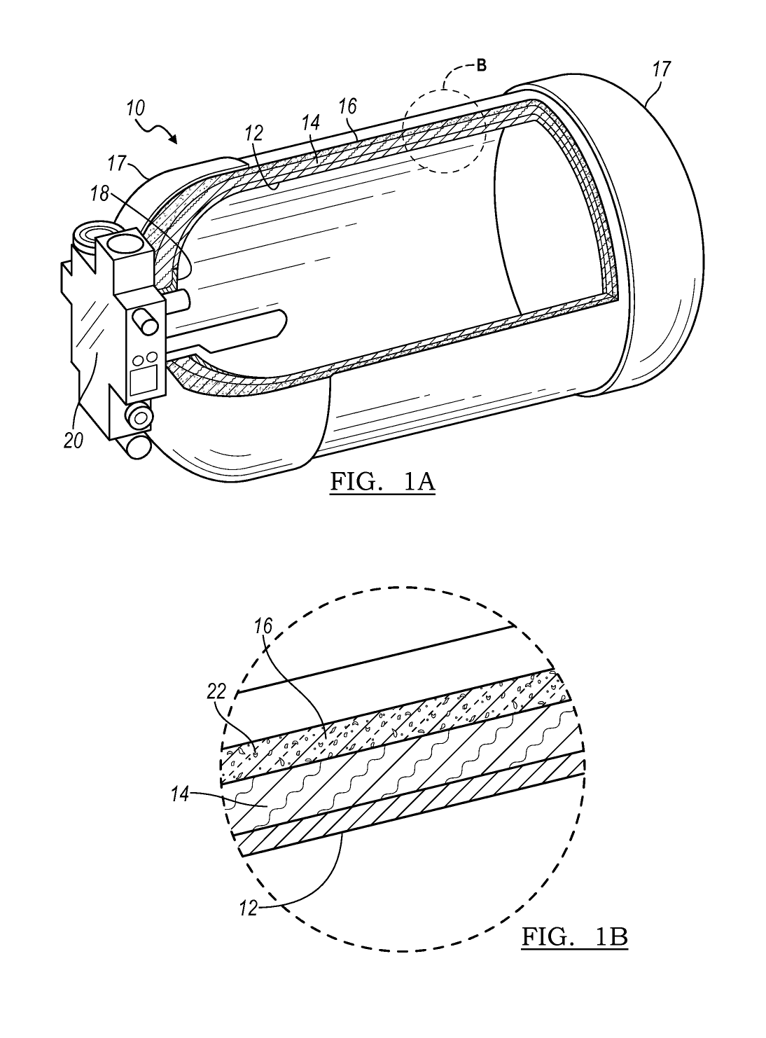

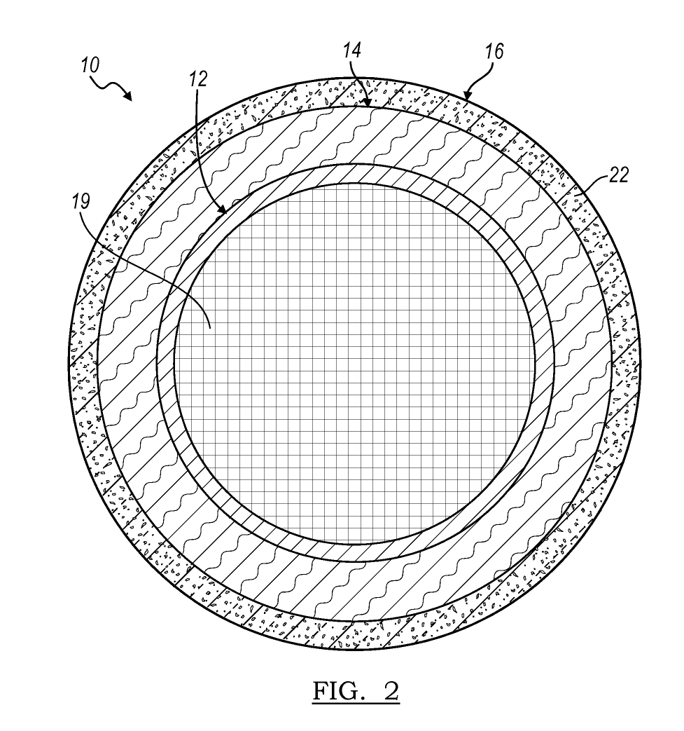

Referring now FIGS. 1A, 1B, and 2, a pressurized vessel embodying the principles of the present invention is illustrated therein and designated at 10. As its primary components, the pressure vessel 10 includes an inner shell 12, an intermediate shell 14, and an outer shell 16. The vessel 10 has a substantially cylindrical shape and is adapted to hold a pressurized fluid 19, such as, for example, hydrogen gas and oxygen gas, a liquid, or both a liquid and a gas.

Note that depending on the application of the vessel 10, the vessel may have any desired shape that is non-cylindrical. Further, the vessel 10 may include additional layers, such as, for example, a barrier layer, a foil layer, a porous permeation layer, and the like, as desired, similar to those disclosed in U.S. patent Ser. Nos. 11/847,007 and 11/9576,8632, the contents of which are incorporated herein by reference in their entirety.

The inner shell 12 of the vessel 10 is a hollow container adapted to store pressurized fluid. In particular applications, the inner shell 12 is formed of a polymer material. In some applications, the inner shell 12 can be formed from multiple layers. The inner shell 12 can be formed by blow molding, extrusion blow molding, rotational molding, or any other suitable process. As shown in FIG. 1, the inner shell 12 has a cylindrical shape; the inner shell, however, may have any desired shape that is not cylindrical depending on how the vessel 10 is employed.

As shown, the inner shell is formed over an exterior portion of, or on an interior portion of, a finish, such as, for example, a metallic boss 18, to facilitate fluid communication between the interior and the exterior of the vessel 10. In particular, the metallic boss 18 provides fluid communication to the exterior of the vessel 10 through a valve 20. Note, however, that the metallic boss may facilitate fluid from the interior of the vessel 10 to exit the vessel 10 through any suitable fitting, such as, for example, a nozzle, a conduit, or a pressure relief valve.

The inner shell 12 may be formed from a plastic such as polyethylene, PET, ethylene vinyl alcohol, or an ethylene vinyl acetate terpolymer. In some implementations, however, the inner shell 12 can be formed from other suitable moldable materials, such as, for example, a metal or a glass.

The intermediate shell 14 of the vessel 10 is formed over the inner shell 12 and is positioned between the inner shell 12 and the outer shell 16. The intermediate shell 14 has substantially cylindrical shape. As shown, the intermediate shell 14 is in direct contact with the inner shell 12. The intermediate shell 14 may be formed from any moldable material such as, for example, a metal or a plastic. Alternatively, the intermediate shell 14 can be formed with a filament winding process. In applications where the intermediate shell 14 is formed by a filament winding process, the intermediate shell 14 can be formed from a carbon fiber, a glass fiber, a composite fiber, a fiber having a resin coating, or any other suitable fiber. The material used to form the intermediate shell 14 may be selected based on the process employed to affix the intermediate shell 14 to the inner shell 12, the use of the vessel 10, and the properties of the fluid 19 stored in the vessel 10.

The outer shell 16 of the vessel 10 is disposed over at least a portion of the intermediate shell 14. For the vessel 10 shown, the outer shell has a substantially cylindrical shape, and is in direct contact with the intermediate shell 14. The outer shell is formed from a glass fiber coated with a high temperature epoxy resin 22 with a filament winding process. Alternatively, the glass fiber may be impregnated with the epoxy resin 22. Note that the epoxy resin 22 is a high temperature resin that in certain applications is different than the resin used in the intermediate shell 14 when the intermediate shell 14 is formed from a fiber with a resin coating. In such arrangements, the high temperature epoxy resin 22 deteriorates at a higher temperature than the epoxy resin employed to form the intermediate shell 14. Note also, the outer shell 16 may have a thickness that is greater than the glass fiber outer shell of a typical pressure vessel.

The epoxy resin 22 facilitates bonding of the outer shell 16 with the intermediate shell 14. In addition to the outer shell providing gravel impact protection to the vessel 10, the use of the high temperature epoxy resin 22 provides a higher heat distortion temperature. Accordingly, the used of the high temperature epoxy resin 22 may delay and reduce the formation of decomposition products which may cause auto-ignition of the composite material at elevated temperatures.

Depending on the use of the vessel 10, the outer shell 16 may be formed from a carbon fiber, a composite fiber, or any other suitable fiber that is coated or impregnated with the epoxy resin 22 that is adapted to be filament wound. Additional material may be disposed on the surface of the shell 16 by a spraying process, a coating process, a dipping process, or any other suitable process. For example, a foam dome 17 may be formed on either end of the vessel 10 over the outer layer 16 to provide additional drop impact protection the vessel 10.

In some implementations, the high temperature epoxy resin 22 is a high temperature filament winding resin which is a bis-A epoxy combined with a liquid amine curative. In a particular implementation, a Epicote Resin 862 (a liquid epoxy) is combined with an Epikure curing agent W (a liquid aromatic amine) and an accelerator such as Epikure curing agent 537. This combination provides a glass transition temperature of about 300° C. when cured at about 177° C.

The description of the invention is merely exemplary in nature and variations that do not depart from the gist of the invention are intended to be within the scope of the invention. Such variations are not to be regarded as a departure from the spirit and scope of the invention.

What is claimed is:

1. A pressure vessel comprising:
an inner shell formed from a moldable material, the inner shell having an inner surface that defines a cavity;
an intermediate shell formed over the inner shell; and
an outer shell formed over the intermediate shell, wherein the outer is formed with a high temperature epoxy resin.

2. The pressure vessel of claim 1 wherein the outer shell is formed from a fiber.

3. The pressure vessel of claim 2 wherein the fiber is a glass fiber.

4. The pressure vessel of claim 2 wherein the fiber is carbon fiber.

5. The pressure vessel of claim 2 wherein the fiber is a composite fiber.

6. The pressure vessel of claim 2 wherein the fiber is coated with the epoxy resin.

7. The pressure vessel of claim 2 wherein the epoxy is impregnated with the epoxy.

8. The pressure vessel of claim 1 wherein the epoxy resin is a bis-A epoxy combined with an amine curative.

9. The pressure vessel of claim 1 wherein the epoxy resin has a composition of a Epicote Resin 862 combined with an Epikure curing agent W and an Epikure curing agent 537 accelerator.

10. The pressure vessel of claim 1 wherein the epoxy adheres the outer shell to the inner shell.

11. The pressure vessel of claim 1 wherein the inner shell is a plastic, a metal, or a glass.

12. The pressure vessel of claim 1 wherein the inner shell if made of a plastic selected from the group consisting of polyethylene, PET, ethylene vinyl alcohol, and ethylene vinyl acetate terpolymer.

13. The pressure vessel of claim 1 wherein the intermediate shell is a plastic or a glass.

14. The pressure vessel of claim 1 wherein the intermediate shell is formed from a fiber.

15. The pressure vessel of claim 14 wherein the fiber is selected from the group consisting of a carbon fiber and a glass fiber.

16. The pressure vessel of claim 15 wherein the intermediate shell is also formed with an epoxy resin.

17. A pressure vessel comprising:
an inner shell formed from a moldable material;
an intermediate shell formed over the inner shell, the intermediate shell being formed of a carbon fiber composite and a first epoxy resin; and
an outer shell formed over the intermediate shell, wherein the outer shell is formed of a fiber and a second epoxy resin that deteriorates at a higher temperature than the first epoxy resin.

18. The pressure vessel of claim 17 wherein the fiber of the outer shell is a glass fiber.

19. The pressure vessel of claim 17 wherein the fiber of the outer shell is selected from the group consisting of a carbon fiber and a composite fiber.

20. A pressure vessel comprising:
an inner shell formed from a moldable material;
an intermediate shell formed over the inner shell, the intermediate shell being formed of a carbon fiber composite and a first epoxy resin;
an outer shell formed over the intermediate shell, the outer shell being formed of a glass fiber and a second epoxy resin that deteriorates at a higher temperature than the first epoxy resin; and
a metallic boss attached to an end of the inner shell to provide fluid communication from the interior of the vessel to the exterior of the vessel.
